(19) United States
(12) Patent Application Publication
(10) Pub. No.: US 2021/0406861 A1
(43) Pub. Date: Dec. 30, 2021

(54) ELECTRONIC DEVICE IDENTIFICATION

(71) Applicant: MOBILE TECHNOLOGY HOLDINGS LIMITED, Douglas (IM)

(72) Inventors: Sean Anthony Edmiston, Tintenbar, NSW (AU); Carl Norman, Glenmore Park, NSW (AU); Michael John Wilson, Coogee, NSW (AU)

(21) Appl. No.: 17/289,167

(22) PCT Filed: Oct. 25, 2019
(86) PCT No.: PCT/AU2019/051177

§ 371 Date: Apr. 27, 2021

(30) Foreign Application Priority Data
Oct. 30, 2018 (AU) 2018904106

(51) Int. Cl. G06Q 20/20; H04L 29/06

(52) U.S. Cl. CPC G06Q 20/206; G06Q 20/208; H04L 63/0876

(57) ABSTRACT

A system and method to identify an electronic device 5, by detecting spurious emissions 4 in the form of electromagnetic waves which are radiated from the device 5. Once identified, the device 5 may be used to authorise an action associated with the device, such as, a financial transaction conducted at a user terminal 3 in a retail outlet.

### BACKGROUND OF THE INVENTION

The present invention relates to a system and method for the identification of an electronic device.

The present invention also relates to a system and method for the authentication of an action, such as, but not limited to, a retail or financial transaction.

More particularly, the present invention relates to a system, apparatus and method for detecting spurious emissions, in the form of electromagnetic waves, which emanate from a user's electronic device, such as a user's cellular phone, then verifying if the spurious emissions match a stored signature for the particular electronic device, and, if so, providing an appropriate authorisation for the action, such as the transaction, to occur.

### DESCRIPTION OF THE PRIOR ART

Any reference herein to known prior art does not, unless the contrary indication appears, constitute an admission that such prior art is commonly known by those skilled in the art to which the invention relates, at the priority date of this application.

Transaction fraud is a growing problem internationally. This problem has prompted the industry to look at increasing the levels of security for credit card, on-line transactions, etc.

Concern about identity theft is also growing. It is now increasingly common to have personal details of customers stolen from company databases.

Smart phones are increasingly being used to conduct banking and other transactions. These transactions are convenient from a customer's point of view because they reduce the need for carrying additional credit cards. Mobile transactions are carried out on many different devices e.g. smart phones, watches, tablets, computers etc.

In seeking to prevent fraud, a number of methods have been developed to verify those transactions. Some devices, such as smart phones, may have the capability to download a customised application (App) to assist in the verification process. However, not all devices have this capability and/or not all users may download and/or update such Apps.

Another specific example of using mobile device identification for enhanced transaction security is the bCODE scanner created by the Applicant of the present invention, Mobile Technology Holdings Limited (MTHL). The bCODE scanner captures an image of the screen of a mobile device in order to read the displayed bCODE token. The token serves as a unique identifier that is sent to a mobile device to authenticate the use of a ticket, voucher, or, to initiate a payment or loyalty transaction.

There are two potential drawbacks with this system. The first drawback is that customers may send their bCODE token to another mobile device, which this is somewhat equivalent to sending a credit card number or Personal Identification Number (PIN) number, with the associated inherent risks. Whilst the initial “sharing” is intentional, the unintended consequence is a lack of security and control of this information, which may lead to fraud. A second drawback is the potential theft of bCODEs and their subsequent fraudulent use.

Using biometric data to verify transactions is also becoming increasingly common. This data is often in the form of photographs, fingerprints, palm prints and iris scans. Voice identification is now also possible, and deoxyribonucleic acid (DNA) verification is also being proposed. The aim of such biometric security measures is to identify the person conducting the transaction.

Biometric information is extremely personal, which may mean that there is likely to be some resistance for some of this information to be used for security purposes. A person can't easily replace their identity if it is stolen. Also, some biometrics can be difficult and/or expensive to measure e.g. iris scans. Some biometrics can also be affected by environmental conditions, for example, facial recognition may be influenced by lighting conditions. More sophisticated techniques are available but they are also more complex and expensive to implement.

With each of the aforementioned forms of two-factor authentication (2FA), a user needs to provide two things, a password and something else such as a code which is typically sent to the user's mobile or other electronic device by short message service (SMS) or by email, or, the user's fingerprint must be provided, before the user can access their account. This method of verifying a transaction provides an increased layer of security.

It is known that all electronic devices emit electromagnetic waves.

Measuring these emissions from electronic devices is known for radiation compliance testing (e.g. CE (Conformite Europeene) marking for Europe, FCC (Federal Communications Commission) marking for the United States). These tests are performed in specialist laboratories with calibrated high-performance equipment. The aim of the compliance testing is to check if the radiated signals from a device are below a threshold level to ensure unsafe levels of radiation are not emitted from the electronic devices, which can have adverse health effects to users. If the device fails the test, appropriate mitigation measures are required, or, redesign may be necessary.

Compliance testing labs often use custom designed laboratories with highly trained staff and expensive equipment. The measurements are standardised, slow and methodical with the aim of being reproducible.

US 2008/0209543A1 describes a method, system and product for identity verification. It compares electromagnetic signals transmitted from transponder devices to reference signatures that have been historically recorded to verify a user's identity. The electromagnetic waves described in US 2008/0209543A1 are intentional purposely produced signals.

WO 2016/182506A1 describes methods and systems for authenticating user device based on ‘ambient’ electromagnetic signals. It allows the authentication of a user's device or action thereon by detecting the plurality of transmitted electromagnetic signals present in a location. The user's device, such as their mobile phone, receives intentionally produced the electromagnetic signals transmitted by electronic devices in the surrounding area, compares these to pre-recorded signals, and authenticates the user's device based on the results of the comparison.

### SUMMARY OF THE INVENTION

The present invention seeks to provide a system and method to identify an electronic device.

The present invention also seeks to provide an apparatus and method to verify a transaction using an electronic device, such as, but not limited to, a smart phone, smart watch, tablet, laptop, or other electronic device.

The present invention also seeks to provide an apparatus and method which will provide an increased level of security for financial and/or retail transactions.

The present invention also seeks to provide an apparatus and method which minimises the possibility of transaction fraud.

In one broad form, the present invention provides a system to identify an electronic device, including: a detector, adapted to detect spurious emission from said electronic device; a memory, containing a stored signature, the stored signature being representative of the spurious emission profile of a respective electronic device; and, a processor, adapted to compare said detected spurious emission with said stored signature and determine the identity of said electronic device is validated.

Preferably, said electronic device includes a mobile phone, an electronic watch, an electronic key, a computer, or any other electronic device which is carried by, implanted in, used by or otherwise typically associated with a particular user.

Also preferably, said detector is incorporated in or associated with a POS terminal in a retail outlet, a financial institution, a restaurant, or any other service industry.

In various preferred forms, the system is used in combination with another authentication apparatus or method, such as, but not limited to:

a bCODE scanner;

a QR code scanner;

a PIN device;

a biometric apparatus;

an image scanner;

a temperature scanner; and,

a signal sniffer detector.

Also preferably, the system uses a plurality of detectors for detection of spurious emissions from a plurality of electronic devices.

Also preferably, said detector is adapted to detect spurious electromagnetic waves emanating from a user's electronic device and thereby produce said detected spurious emission profile.

Also preferably, said electromagnetic waves includes any one or combination of radio waves, microwaves, or other high frequency waves.

Also preferably, the detector includes at least one antenna to detect characteristics of electromagnetic waves emitted from at least one electronic devices, the characteristics including any one or combination of:

frequency, frequency range and/or sets of frequencies;

intensity;

modulation;

signal shape; and,

change in emission characteristics.

Also preferably, said processor uses an algorithm based on a combination of characteristics of the spurious emissions to determine if the identity of said electronic device is validated.

Also preferably, said detector is incorporated in, or associated with a lock or other security device.

Also preferably, said memory and/or said processor is located remote from the detector(s), and communication therebetween is via a dedicated or public communication channel and/or via the internet.

Also preferably, said memory is in the form of a database, which is adapted to store a plurality of stored signatures, each representative of a respective user's electronic device.

Also preferably, a predetermined variance is permitted in determining whether the detected spurious emission matches the stored signature.

In yet another broad form the present invention provides a method of identifying an electronic device, including the steps of: detecting spurious emissions from said electronic device; comparing the detected spurious emissions with a stored signature which is representative of a spurious emission profile of a device; and, determining if the identity of said electronic device is validated.

Preferably, in said comparing step, said detected spurious emissions from said electronic device are compared with a plurality of stored signatures stored in a database.

Also preferably, in said determining step, an algorithm is used which based on a combination of characteristics of the spurious emissions, to determine if the identity of said electronic device is verified.

Also preferably, in said determining step, a predetermined variance is permitted in determining whether the detected spurious emissions matches the stored signature.

In yet another broad form, the present invention provides an authentication apparatus, including: a detector to detect a spurious emission from an electronic device, the device including a mobile phone, an electronic watch, an electronic key, a computer, or any other electronic device which is carried by, implanted in, used or otherwise typically associated with a particular user; and a processor to compare said detected spurious emission with a stored signature and provide an authentication signal if the identity of the device is validated.

Preferably, said detector is incorporated in, or associated with a POS terminal in a retail outlet, a financial institution, a restaurant, or any other service industry.

In various preferred forms, the apparatus is used in combination with another authentication apparatus or method, such as, but not limited to:

a bCODE scanner;

a QR code scanner;

a PIN device; and.

a biometric apparatus;

an image scanner;

a heat scanner; and

a signal sniffing detector.

In yet another broad form, the present invention provides an authentication method, including the steps of: detecting a spurious emission from an electronic device; comparing said spurious emission with a pre-stored signature profile of said device; and, providing an authentication signal if said spurious emission matches said pre-stored signature profile.

Preferably, in said comparing step, said detected spurious emissions from said electronic device are compared with a plurality of stored signatures stored in a database.

Also preferably, in said determining step, an algorithm is used which is based on a combination of characteristics of the spurious emissions, to determine if the identity of said electronic device is verified.

Also preferably, in said determining step, a predetermined variance is permitted in determining whether the detected spurious emission matches the stored signature.

In yet another broad form, the present invention provides a system for authorising a transaction, including: a user terminal, for a user to initiate a transaction; a memory, containing a plurality of stored signatures, each stored signature being representative of the spurious emission profile of a respective user's electronic device; and a processor, adapted to compare said detected signature with said stored signatures, and, when a match is identified, provide an authorisation signal to the user terminal to authorise the transaction.

Preferably, including a plurality of user terminals and detectors associated therewith.

Also preferably, each user terminal and detector is incorporated in, or associated with a POS terminal in a retail outlet, a financial institution, a restaurant, or any other service industry.

Also preferably, each user terminal and detector includes another authentication apparatus, such as, but not limited to:

a bCODE scanner;

a QR code scanner;

a PIN device;

a biometric apparatus;

an image scanner;

a heat scanner; and

a signal sniffing detector.

Also preferably, said memory and processor are located remotely from each user terminal and associated detector.

In yet another broad form, the present invention provides a method of authorising a transaction, including the steps of: receiving a request to initiate a transaction by a user at a user terminal; detecting spurious emissions from an electronic device presented by the user to a detector associated with said user terminal; comparing said detected spurious emissions or a detected signature representative thereof with a stored signature profile for the respective user's device; and, authorising the transaction by providing an authorisation signal to the user terminal when the detected emissions or signature matches said stored signature profile.

In yet another broad form, the present invention provides a detector apparatus adapted to detect spurious emissions radiated from an electronic device to thereby identify or authenticate the device.

Preferably when the device is identified or authenticated, an action associated with the electronic device is thereafter authorised.

Also preferably, said action includes a financial transaction.

Also preferably, said apparatus is embodied in the form of a user terminal.

Also preferably, said action includes actuating a lock or other security device.

Also preferably, said detector apparatus includes, or communicates with, a memory containing at least one stored signature profile, each of which is representative of the spurious emission profile of a respective user's device.

In yet another broad form, the present invention provides a processor adapted to: receive an input signal representative of a spurious emission from an electronic device presented to a user terminal by a user; compare said detected spurious emissions with at least one stored signature, each said stored signature being representative of a spurious emission profile of a respective device; and validate the identity of said electronic device; and, provide an authorisation signal to the user terminal.

Preferably said processor is located remotely from said user terminal.

### BRIEF DESCRIPTION OF THE DRAWINGS

The present invention will become more fully understood from the following detailed description of preferred but non-limiting embodiments thereof, described in connection with the accompanying drawings, wherein:

FIG. 1 shows, in schematic form, an overview of an electronic device identification system, in accordance with a preferred embodiment of the present invention;

FIG. 2 shows a flowchart, showing the main steps in a preferred implementation of the method of electronic device identification, in accordance with the present invention;

FIG. 3 shows, in schematic form, an overview of an alternative but also preferred embodiment of the electronic device identification system of the present invention;

FIG. 4 shows, in schematic form, a more detailed overview of the main components of the apparatus of a preferred embodiment of the present invention;

FIG. 5 shows a flowchart, showing the main steps in the method of electronic device identification of the implementation shown in FIG. 4;

FIG. 6 shows, also in schematic form, an exemplary embodiment of the present invention;

FIG. 7 illustrates a block diagram of an alternative but also preferred system implementation of the present invention;

FIG. 8 illustrates a preferred but non-limiting implementation of a circuit overview of the present invention;

FIG. 9 illustrates a spectrogram image which may be utilised in an exemplary embodiment of the present invention; and,

FIG. 10 illustrates a graphical representation of a comparison of 2 different signature images taken from 2 different cellular phone devices.

### DETAILED DESCRIPTION OF PREFERRED EMBODIMENTS

Throughout the drawings, like numerals will be used to identify like features, except where expressly otherwise indicated.

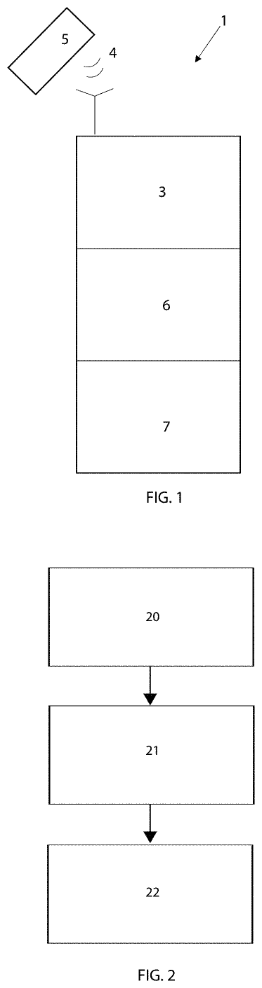

FIG. 1 shows a schematic diagram of a preferred implementation of the system in accordance with the present invention. The system, generally designated by the numeral 1, is adapted to ‘identify’ a particular electronic device 5.

The system 1, includes a detector 3, a memory 6, and, a processor 7. The detector 3 is adapted to detect a ‘spurious’ emission 4 of electromagnetic waves from the electronic device 5.

The electronic device 5 may be any electronic device, such as a mobile phone, an electronic watch, an electronic key, a computer, or any other electronic device which is carried by, implanted in, used, or otherwise typically associated with a particular user.

Throughout this specification, the term ‘spurious’ emission is used to define any unintended, unwanted, or out of band emission, which is inherent in any electronic device. That is, a ‘spurious’ emission should be understood to include any electromagnetic radiation or signal which emanates from an electronic device, which, when powered, is not deliberately or intentionally created or transmitted from the device. This may include, without limitation, any electromagnetic signal emission of any frequency, a harmonic or other signal, a parasitic emission, and intermodulation product, a frequency conversion product, or noise, etc. which may be outside the intended emissions of the electronic device.

The inventor has identified that the ‘spurious’ emission profile from each electronic device is unique to that particular device. This unique ‘spurious’ emission profile, is somewhat analogous to a ‘fingerprint’ for that particular device, and will herein be referred to as the unique ‘signature’ for that device. The ‘signature’ for each electronic device can therefore, in accordance with the present invention, be captured and stored, and thereafter, be compared with a ‘detected’ or measured ‘signature’ to determine whether it matches and therefore authenticates the measured ‘signature’.

As will however be appreciated by persons skilled in the art, all physical electronic components have a natural variation or tolerance. Modern manufacturing techniques can minimise but not eliminate this tolerance, since it is inherent to the physical construction of each component. The unintentional, or spurious radio emissions, given off by all electronic devices is sensitive to the tolerances of the various electronic components used.

Throughout this specification, the term ‘user’ also is intended to have broad definition, and may include, without limitation, any person initiating an action. This may include, for example, a transaction of a buyer, a seller, a merchant, a customer, a vendor, a purchaser, etc. Likewise, the term ‘user terminal’ should also have broad definition, and should include any terminal or like apparatus which a user may use to conduct the transaction, whether or not owned by the user, a vendor, or otherwise. Similarly, the term ‘user's device’, ‘user's electronic device’, and like terms should also be construed broadly to include any electronic device which may be used by a person to conduct an action, including a transaction, and may include a mobile phone, smart phone or cell phone, an electronic watch, or any other device which may be carried by or implanted in a person which may be capable of being used to conduct a transaction.

Referring back to FIG. 1, the memory 6 of the system 1 is adapted to contain at least one pre-stored ‘signature’, each of which is representative of the spurious emission profile or signature of a particular electronic device 5.

The processor 7 of the system 1 is then adapted to compare the spurious emission detected by the detector 3, and, determine if the identity of the electronic device 5 is validated.

FIG. 2 shows a simplified flowchart of the steps performed in this process in operation. Step 20 shows the detection of the spurious emissions from the electronic device. Step 21 shows how these detected spurious emissions are compared with a stored signature which is representative of a spurious emission profile of a particular electronic device 5. Step 22 shows how the identity of the electronic device is determined and validated.

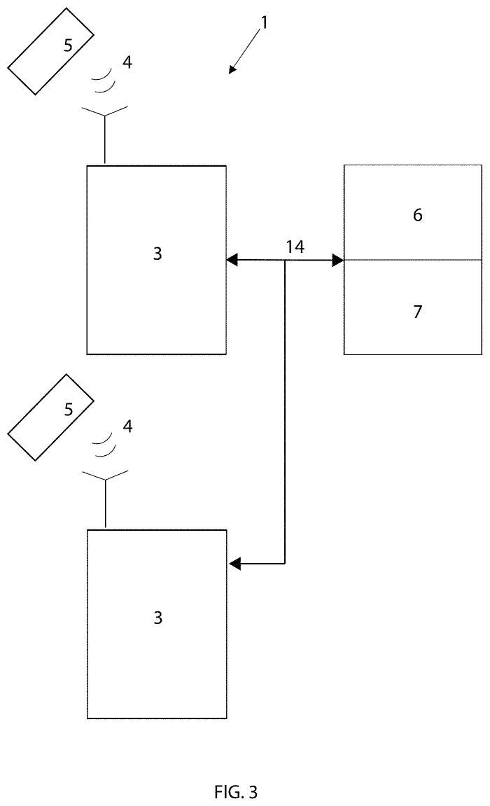

FIG. 3 shows a simplified block diagram of a system 1 of the present invention wherein the detector 3 is incorporated in, or associated with, a point of sale (POS) terminal in a retail outlet, a financial institution, a restaurant, or, in any other service industry. The detector 3, in this case, is located at the retail outlet, and communicates via a communication link 14 with a remotely located processor 6 and database 7. The system 1 shown in FIG. 3 may include a plurality of detectors 3, each located at the same outlet or different retail outlets, each to detect spurious emissions from any one of a plurality of electronic devices 5 which may be used to conduct or authenticate a financial transaction.

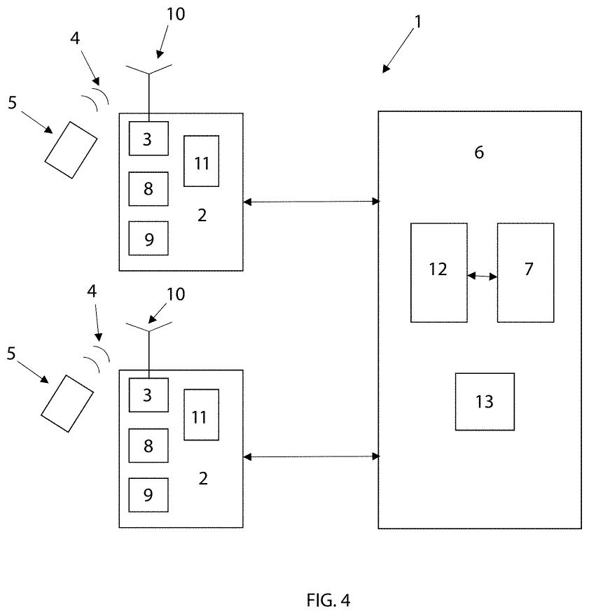

FIG. 4 shows a more detailed block diagram of a system 1 of the present invention. The main components of the apparatus, generally designed by the numeral 1, include one or more user terminals 2, each user terminal 2 including a detector 3, to detect electromagnetic waves 4 emitted from a user's electronic device 5, and, a processor 6 which is adapted to compare a signature of the electronic device with a scanned electronic signature for that device which is stored in a memory 7 of the processor 6.

The user terminal 2 may include an input/output device, including, for example, a keypad 8, and display device 9, for a user to initiate a transaction, and, to display information back to the user in relation to the progress of the transaction.

Once a transaction is initiated by, for example, a user providing input information via the keypad 8, the detector 3 may be activated. The detector 3 may include an antenna 10 which can detect electromagnetic waves 4 spuriously emitted from a user's electronic device 5.

A processor 11 may then generate a signature which is representative of the electromagnetic waves spuriously emitted from the user's electronic device 5.

A system processor 6 may include a comparator 12 which compares this detected signature with a signature which is previously stored in a memory 7 of the system processor 6. When the detected signature matches the stored signature, the processor 6 provides an authentication signal back to the user terminal to thereby authenticate a transaction.

As such, it will be understood that the present invention therefore provides authentication that the particular user's electronic device 5 is being used, determined by validating that the electromagnetic waves emitted from the electronic device 5 and substantially identical to a predetermined signature of that particular device 5.

As will be understood by persons skilled in the art, the detector 3 and/or processor 7 used in the present invention preferably detect and/or process ‘near field’ signals.

That is, the system of the present invention is preferably implemented to detect only the spurious emission signals which emanate from the phone or other electronic device which is held in close proximity to the scanner or user terminal 3, using an appropriate antenna, detection circuit and/or processing circuitry.

This is important such that only the spurious emissions signals which are coming from the relevant phone/electronic device, and not from other nearby ‘noise’ sources, are detected and processed. As will be appreciated by persons skilled in the art, ‘spurious emissions’ are given off by any electronic device, so, by using a ‘near field’ detector, this will ensure that any extraneous ‘noise’ signals emanating from other electronic devices, etc. which happen to be in the vicinity of the particular electronic device which is desired to be detected, will not cause interference with the signals which are desired to be detected. Therefore, by using a ‘near field’ detector, and by positioning the phone or other electronic device in close proximity to the detector, this problem is minimised.

Furthermore, from a fraud prevention perspective, this is ensures that only the particular phone conducting the transaction, and not a nearby phone, is being detected.

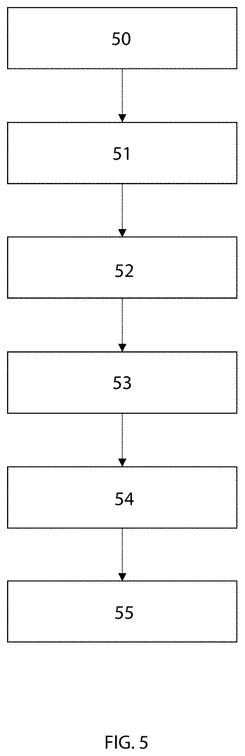

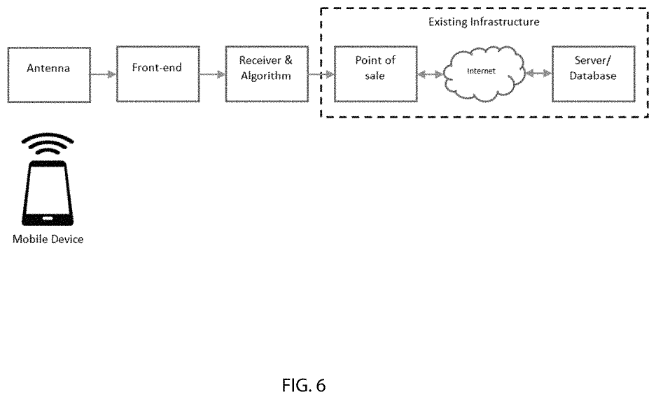

FIG. 5 shows a flow diagram showing the main steps in the method of authentication of a transaction, in accordance with the present invention.

As shown in FIG. 5, the system firstly receives a request to initiate a transaction by a user inputting a transaction request at a user terminal, as shown in block 50. Thereafter, as shown in block 51, this initiates the system, which then activates a detector to detect electromagnetic waves emitted from a user's electronic device, as shown in step 52. At step 53, a signature representative of the electromagnetic waves emitted from the user's electronic device may be produced. Thereafter, at step 54, the detected signature may be compared with a stored signature. If the detector signal matches the stored signal, then, at step 55, an authentication signal is then provided back to the user terminal, to authenticate the transaction.

As will be understood by persons skilled in the art, the electronic device may be any one from a large group of devices. These devices are preferably portable in nature, such as, but not limited to a user's smart phone, smart watch, laptops or tablet computer, etc. The electronic device could also be a device which is implanted in a user, for example under the users skin on or near their hand or wrist, for convenience of use.

The user terminal may take a variety of forms, but may typically be a point-of-sale (POS) terminal in a retail outlet, a financial institution, a restaurant, etc.

The electromagnetic waves spuriously emitted from the electronic device and thereafter detected by the detector, may be any one or combination of a variety of different frequency waves, including, for example, radio waves, microwaves or other high frequency waves.

The electromagnetic waves may have a number of different characteristics which may, in the present invention be used separately or in any combination. These may typically include frequency, a frequency range and/or sets of frequencies, intensity, signal shape and/or change in emission characteristics, etc.

For example, the Applicant has been monitoring frequencies of electromagnetic waves less than about 200 kHz, however, it will be understood by persons skilled in the art that other frequency signals may be alternatively or additionally monitored in implementing the invention.

Once the electromagnetic signals are detected, the processor may provide a signature which is uniquely representative of the particular device. This may be obtained using an algorithm which uses any combination of the detected characteristics of the electromagnetic waves. It will be appreciated by persons skilled in the art that the specifics of any algorithm will be variable depending upon the frequencies, strengths, and other characteristic of the electromagnetic waves which are spuriously emitted from the particular device(s) to be detected, and the detection circuitry used to detect these spurious emissions. As such, persons skilled in the art will appreciate that a wide variety of algorithms may be used, and the specifics of the algorithms will be apparent to persons skilled in the art.

One such algorithm may determine a match of location (frequency) and height (amplitude) of the prominent peaks in the waveform. The matching may be performed by calculating a score based on how close each of these peaks are (where 1 is a perfect match and anything less than a perfect match is less than 1).

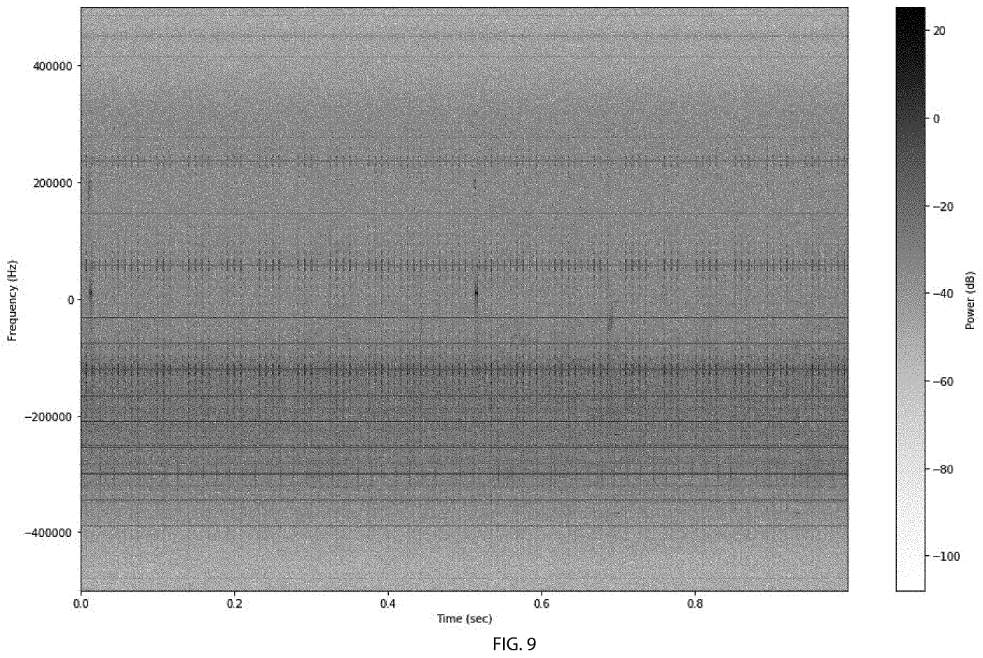

An alternative algorithm may be used when the signature consists of the 2 dimensional image such as FIG. 9. Image processing techniques are then applied to this for example compression techniques to reduce the size of the signature, and conventional image comparison techniques to determine if two images are the same. A particularly powerful approach is to apply modern AI/ML techniques and treat the signature matching as an image classification problem, for which there are various existing techniques.

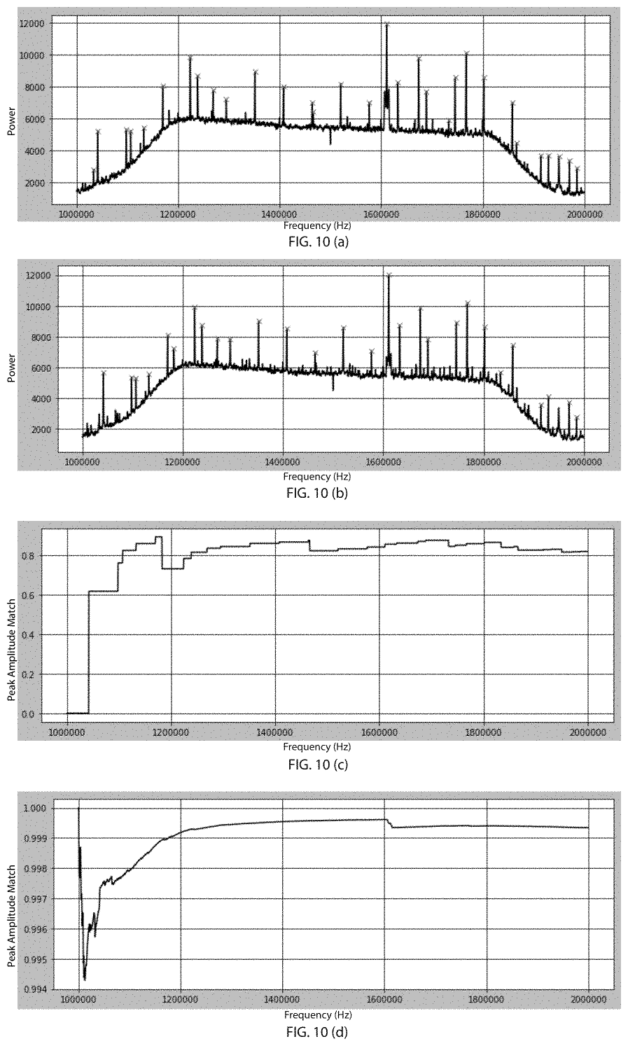

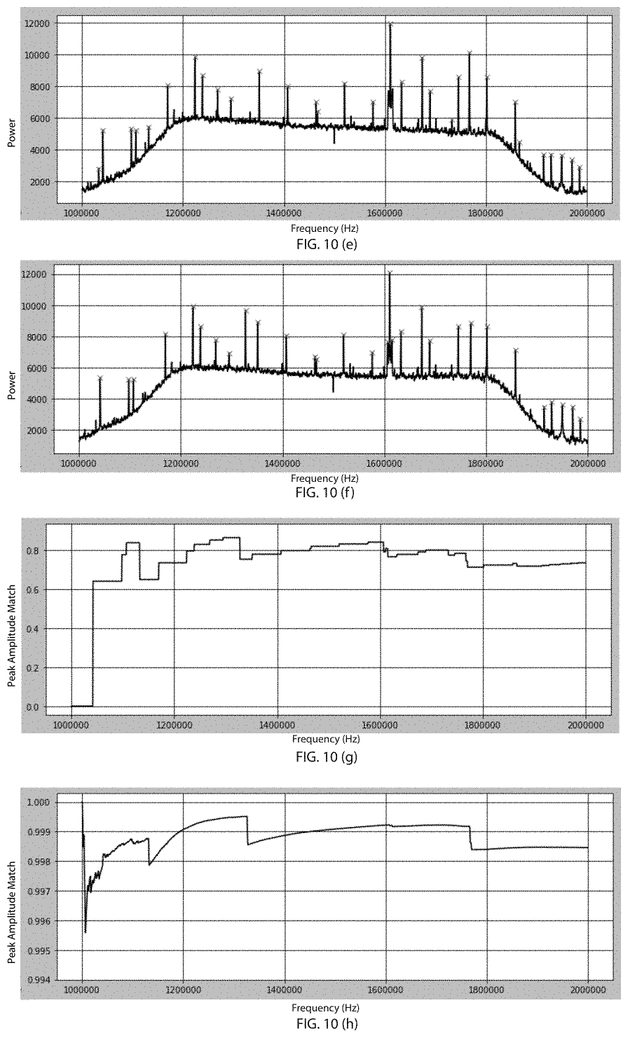

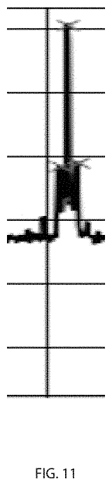

An alternative algorithm may focus on secondary peaks. FIG. 11 shows a close up of one section of a signal similar to that of FIG. 10. In particular it will be seen that there is a prominent primary peak but either side of this there are smaller secondary peaks. These secondary peaks are very susceptible to component tolerances in the electronic circuits that produced them and therefore are good candidates for a unique signature. This technique gives additional importance to these particular secondary peaks, so that these secondary peaks are included in the signature when other more prominent primary peaks may be ignored.

Various other algorithms or signal processing techniques will become apparent to persons skilled in the art.

The present invention is preferably embodied using a plurality of user terminals, each of which is capable of detecting the waves emanating from a plurality of user's electronic devices.

Each user terminal is preferably located remotely from the central processor and adapted to communicate via any known communications channel, either hard-wired or wireless, and/or via the internet.

The processor is preferably able to store a plurality of stored signatures, each representative of a respective user's electronic device.

Whilst a high level of accuracy is preferred in the authentication apparatus and method of the present invention, a certain amount of variance may be permitted as to whether a stored signature is determined to match a detected signature. This may typically allow for variances due to changes in the usual electromagnetic waves which may emanate from the same device, due to, for example, using a different number of apps in the device.

The authentication apparatus and method of the present invention may be utilised on its own, or in conjunction with other known authentication method, such as, but not limited to, a bCODE scanner, a QR code scanner, a PIN device, and/or a biometric authentication device.

As will be appreciated, the present invention utilises some known components, such as, user point-of-sale terminals, the internet as a communication channel, and the user's existing electronic devices, such as smart phones, smart watches etc. Some of these components, and their interaction will now be briefly described.

The antenna 10 intercepts at least some of the electromagnetic waves radiated by an electronic device and produces an electric current at its terminals. The antenna may be an individual antenna or a collection of antennas operating as an array.

A front-end processor 3 may connect the antenna to the receiver user terminal 2. The front-end processor may condition the signal for improved reception by the receiver user terminal 2, by providing signal filtering, signal amplification and impedance matching, etc.

The receiver user terminal 2 may typically sample and process the signals received from the antenna 10 and front-end processor 3. The receiver user terminal may typically include an analog-to-digital converter, a computer for processing the signals, data storage and input and output interfaces.

An algorithm may typically run in the processor 2, to process the received signals. The algorithm thereby produces a “signature” for the mobile device based on the received signals (the mobile device's “signature”).

The processor 6 may then check if the electronic device's signature matches the stored or reference signature. This check could additionally be associated with a bCODE transaction.

The electronic device may typically be any portable device used for any transaction, and may include smart phones, mobile phones, cell phones, smart watches, tablets, computers etc. or any other electronic device for conducting a transaction.

When referring to a ‘transaction’, this term should also be construed broadly, and may include, but is not limited to; any form of financial or commercial transaction; including payments, ticketing, vouchers, marketing coupons and loyalty transactions; building assess control; parking entry/exit; airline, bus, rail or other transportation ticketing and/or check-in; goods, parcel, courier and/or postal collection; government services such as food stamps, vouchers for immunisations; etc.

The antenna 10 senses the signal provided by the electronic device and produces a signal.

The front-end processor 2 then receives the signal from the antenna 10 and conditions the signal with the aim of providing improved reception and processing by the receiver 2 and algorithm.

The receiver 2 is the system that is used to sample and process the signals received from the antenna and front-end processor 2.

The algorithm may typically be implemented in software. This software is executed on the computing subsystem of the receiver 2. The algorithm produces the electronic device's signature that is used for security verification.

The processor may then check if the mobile device's signature matches the stored 1 reference signature, which may be held in a database 2 on a remote server 6.

Users may change the particular electronic device that they use. The overall system will then be capable of managing the different signatures associated with a single user.

It will be appreciated that the system of the present invention uses a different method of verifying a transaction from traditional approaches.

The present invention may be used alone, or, in conjunction with other known mobile transaction methods, such as bCODE transaction verification, to support and therefore provide an increased level of security in a transaction.

It will be understood by persons shown in the art that various modifications may be made to the invention which may optimise the invention.

For example the frequency range of the signals measured can be changed to maximise performance.

The Antenna may be optimised to improve sensitivity.

The receiver and algorithm may be varied and optimised to improve or alter the signature derived from the measurements.

Increasing the available computing power will to enable more and finer-detailed information to be extracted for identification.

Improving the algorithm's ability to extract a mobile device's signature will lead to improved identification.

It will therefore be appreciated that the present invention provides an additional layer of security for transactions, particularly using smart phones and like mobile electronic devices.

The invention may be used alone, or in conjunction with other technology to support bCODE transactions, which include payments, ticketing, vouchers and loyalty transactions, or uses the apparatus in association with a QR code scanner.

Mobile device identification can provide enhanced transaction security that is seamless for the customer. When a bCODE is scanned the mobile device's signature can also be captured. No other action is required by the customer.

The Applicant's early test results show that various levels of identification may be possible. The simplest level of identification is being able to recognise the make and the model of a mobile device (e.g. mobile phone). One issue is that many people can have a phone of the same make and model.

A second level of identification is being able to recognise individual mobile devices. Early testing results show that individual phones can be identified even when multiple phones of the same make and model are present.

The mobile device identification system will have a relatively low-cost when compared with the equipment used in compliance testing laboratories. The system will also operate in uncontrolled environments, unlike the tightly controlled test environments.

Relatively low-cost means that the mobile device identification system can be deployed in large numbers.

The mobile device identification system does not rely on personal or biometric information. This provides many security advantages ranging from the point of sale right through the supporting network infrastructure.

One convenient aspect of mobile device identification is that the mobile device that holds the bCODE is also the device whose signature is measured. This can be contrasted with, for example, scanning a bCODE and then trying to photograph the customer in a retail environment.

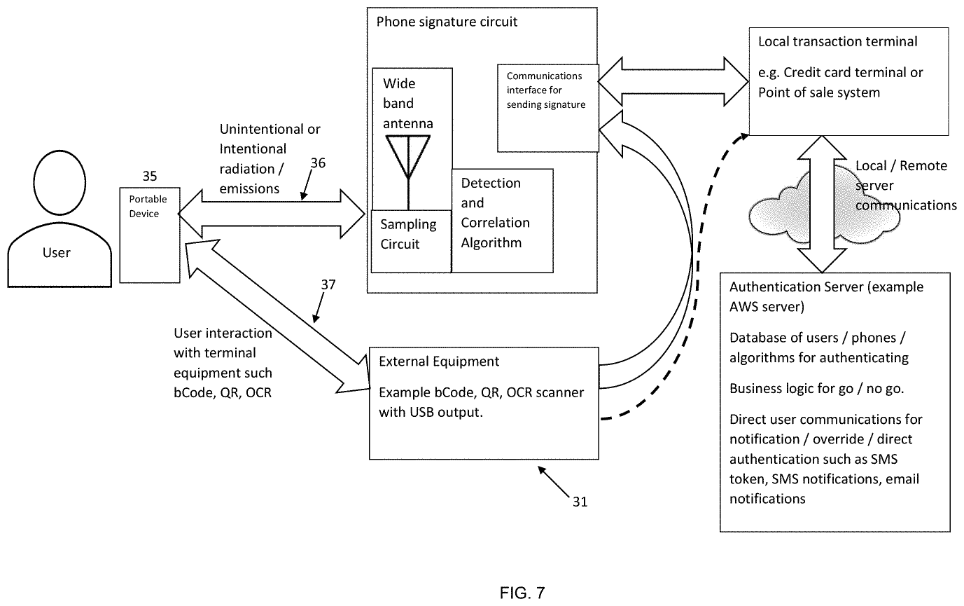

FIG. 7 shows a more detailed block diagram of the components of the system in accordance with another preferred embodiment of the present invention. In this exemplary embodiment, the system utilises the detector as previously described, and as illustrated by block 30, and, in addition, utilises a secondary authentication apparatus as illustrated by the block 31.

Both the detector 30 and secondary authentication apparatus 31 may be integrated in a single user terminal to which the user's device 35 is presented for identification. The spurious emissions 36 from the user's device 35 will be detected by the detector 30 as hereinbefore described, whilst, the additional authentication shown by arrow 37 may, for example, scan a QR code the code or other code shown on the display of the user's device 35.

FIG. 7 therefore shows how the ‘phone signature circuit’ works alongside a bCODE or QR code reading device. The dotted line shows where a ‘normal’ QR code scanner or bCODE scanner would connect to a Point of Sale (POS) system. The orange lines show how the ‘normal’ QR code scanner or bCODE scanner instead would connect to a phone signature circuit that would then connect to the POS system. The phone signature circuit could be embedded inside the device bCODE scanner.

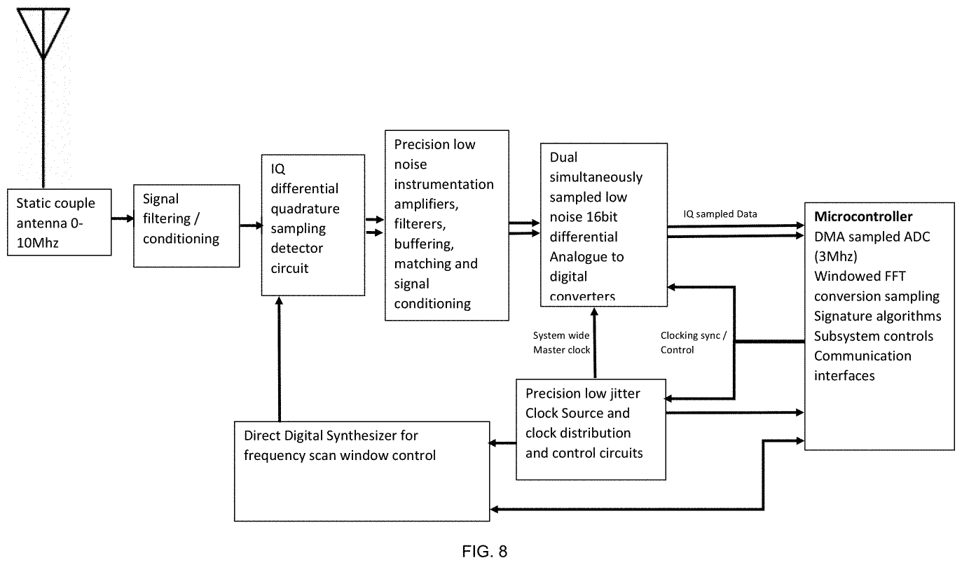

In FIG. 8 is shown a circuit overview of a preferred embodiment of the present invention, showing the main component parts of the hardware of the overall detection system and the main steps in processing the detected signals to authenticate these as being from a particular electronic device.

In FIG. 9 is shown a sample image of a signature of an electronic device, and in particular, of a mobile or cellular telephone. The preferred frequency range is 0-500 kHz. Working in this low frequency range allows for a much cheaper detector circuit to be used than a higher frequency range. This range is also below the 500 KHz-1600 KHz range typically used for AM radio broadcasts which would generate significant interference with this technique. 0-2 MHz is also a very likely range. In this case, careful antenna design allows the detector to attenuate any signals coming from further away than 10-20 cm. (i.e. The antenna mainly picks up signals coming from very nearby devices).

Another range of interest is 2-5 GHz. This is more difficult and therefore more costly. However it has the benefit that the radio wavelengths are now smaller than the size of the phone. This allows even better localization of the signal to remove external noise sources.

Frequencies between 0 and 1 MHz over a period of 1 second as shown in FIG. 9. In the spectrogram image classification approach, an image classification technique (such as a pre-trained neural network) is used to generate a signature directly from such images. This approach is promising because of the extraordinary success of ‘deep learning’ to solve image classification problems.

In FIG. 10 are shown various graphs which illustrate the spurious emissions recorded emanating from example electronic devices, and, graphs showing the correlations made between the emissions to determine whether they match, and are therefore whether they are determined to be from the same electronic device.

In particular, FIGS. 10(a) and 10(b) illustrate the spurious emissions which are measured to emanate from the same mobile/cellular phone device within the 1 Mhz to 2 Mhz frequency range, recorded at two separate times. From a careful observation of FIGS. 10(a) and 10(b), it can be seen that the detected signals are almost identical, but, that there are some variations. This small amount of variation is to be expected within measurable tolerances, etc., as hereinbefore described.

These signals may be compared, to determine whether or not they match, using ‘peak scoring’ techniques, that is, by careful observation and comparison of the ‘peaks’ of the spurious emissions which are measured. That is, they may be compared using traditional signal processing techniques and/or algorithmic techniques based on the location and height of peaks in the signals. The peaks are marked in the graphs with a small ‘x’, for ease of identification.

FIGS. 10(c) and 10(d) illustrate the correlation/comparison between the two detected signals shown in FIGS. 10(a) and 10(b). Each ‘step down’ indicates a ‘mismatch’ in the signatures. As observed, there is only a relatively small ‘mismatch’ around 1.6 MHz. Some mismatches are to be expected since no 2 measurements are expected to be identical, as previously described.

FIGS. 10(e) and 10(f) illustrate the spurious emissions which are measured to emanate from the same brand and type, but different mobile/cellular phone devices. As can be seen, whilst there is some visual similarity between the ‘spurious emission’ graphs, due to the fact that they are of the same brand and model of mobile phone, it can be seen that the detected signals are quite different.

FIGS. 10(g) and 10(h) illustrate the correlation/comparison between the two detected signals shown in FIGS. 10(e) and 10(f). Each ‘step down’ indicates a ‘mismatch’ in the signatures detected from the phones. FIG. 10(h), particularly in comparison to the graph shown in FIG. 10(d), shows there are significant mismatches at 1.15 MHz, 1.3 MHz and 1.75 MHz, indicating that it is indeed a different phone.

Whilst this example shows the detection of spurious emissions within the particular frequency of 1 to 2 MHz, persons skilled in the art will appreciate that a wide variety of frequency ranges may be utilised. Selection of the frequency ranges and other characteristics of the spurious emissions sought to be detected will depend on the particular electronic devices, etc. that are to be measured/detected.

FIG. 11 shows an enlarged view up of a portion of the spectral emission signal shown in FIG. 10 (a). As seen, there is a prominent primary peak, but, either side of this there are smaller secondary peaks. These secondary peaks are very susceptible to component tolerances in the electronic circuits that produced them and therefore are good candidates for unique signature detection. Thus, when analysing the spurious emissions from an electronic device it is expected that a great variances in the amplitude of these secondary peaks would be observed. This analysing and processing technique is similar to the technique that takes advantage of the variation amplitude of the main peaks, however gives additional importance to these particular secondary peaks. These secondary peaks are included in the signature when other more prominent primary peaks may be ignored. It will become apparent to persons skilled in the art that this secondary peak detection technique may additionally or alternatively be used, and that this, along with similar alternative techniques, should be considered to be encompassed within the present invention.

The present invention therefore provides a system to identify an electronic device based on the detection of spurious emissions radiated from the electronic device. When a particular electronic device is identified or authenticated, an action is thereafter authorised the action may include a financial transaction or any other action.

In the preferred implementation of the invention hereinbefore described, the ‘action’ is associated with a financial transaction, and the apparatus is embodied in the form of a user terminal typically provided in a retail outlet.

The authentication method as hereinbefore described may be utilised on its own as a sole form of identification of the electronic device to authorise a transaction. Alternatively, the system and method of the present invention can be utilised in combination with another authentication apparatus. This may include a B code scanner, a QR code scanner, a pin device, a biometric apparatus, etc.

Alternatively, the electronic device may be used for a different form of ‘action’ other than a financial transaction. For example, the electronic device, may alternatively be used to operate a lock on, for example, a door. Once authorised or validated, the door may be opened for access by a user. Other similar actions may likewise be authorised, as will become apparent to persons skilled in the art.

As hereinbefore described, the system of the present invention is adapted to detect spurious emissions of electromagnetic waves emanating from a user's device to be processed and then authenticated. As will be understood by person skilled in the art, electromagnetic waves have a variety of characteristics which may be utilised either alone or in any combination stop such characteristics include frequency, frequency range and/or sets of frequencies, intensities, modulation, signal shape, and changing emission characteristics. The system of the present invention may optimally utilise an algorithm based on any desired combination of these characteristics, as will be readily understood by person skilled in the art.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A system to authenticate the identity of an electronic device being used in a financial transaction, and, if validated, then authorise the financial transaction, the system including:
a spectral emission detector, incorporated in or associated with a point-of-sale (POS) terminal for a user to conduct a financial transaction, the detector being configured to detect any near-field spurious emissions over a spectral frequency range emanating from said electronic device positioned proximal to said detector;
a memory, containing a stored signature, the stored signature being representative of the spurious emission profile of a respective electronic device; and,
a processor, configured to compare said detected spurious emission with said stored signature, and, if the identity of said electronic device is validated, authorise the financial transaction.

2. The system as claimed in claim 1, wherein said electronic device includes a mobile phone, an electronic watch, an electronic key, a computer, or any other electronic device which is carried by, implanted in, used by or otherwise typically associated with a particular user;
wherein said POS terminal is a POS terminal in a retail outlet, a financial institution, a restaurant, or any other service industry; and
wherein the system is used in combination with another authentication apparatus or method such as but not limited to:
a bCODE scanner;
a QR code scanner;
a PIN device;
a biometric apparatus;
an image scanner;
a temperature scanner; and,
a signal sniffer detector.

3. (canceled)

4. (canceled)

5. The system as claimed in claim 1, wherein the system uses a plurality of detectors for detection of spurious emissions from a plurality of electronic devices.

6. The system as claimed in claim 1, wherein said detector is adapted to detect spurious electromagnetic waves emanating from a user's electronic device and thereby produce said detected spurious emission profile:
wherein said electromagnetic waves includes any one or combination of radio waves, microwaves, or other high-frequency waves;
wherein the detector includes at least one antenna to detect characteristics of electromagnetic waves emitted from at least one electronic device, the characteristics including any one or combination of:
frequency, frequency range, or sets of frequencies;
intensity;
modulation;
signal shape; and,
change in emission characteristics; and
wherein said processor uses an algorithm based on a combination of characteristics of the spurious emissions to determine if the identity of said electronic device is validated.

7. (canceled)

8. (canceled)

9. (canceled)

10. The system as claimed in claim 1, wherein said memory or said processor is located remote from the detector(s), and communication therebetween is via a dedicated or public communication channel or via the internet.

11. The system as claimed in claim 1, wherein said memory is in the form of a database, which is adapted to store a plurality of stored signatures, each representative of a respective user's electronic device.

12. The system as claimed in claim 1, wherein a predetermined variance is permitted in determining whether the detected spurious emission matches the stored signature.

13. The system as claimed in claim 1, wherein the detected spurious emission includes a primary peak and two secondary peaks smaller than the primary peak, wherein one secondary peak has a lower frequency than the primary peak, and the other secondary peak has a higher frequency than the primary peak, and wherein the processor is configured to compare the two secondary peaks with the stored signature to validate the identity of the electronic device;
wherein the processor is optionally configured to ignore the primary peak when comparing the detected spurious emission with the stored signature.

14. (canceled)

15. The system as claimed in claim 1, wherein the detector is configured to detect spurious emissions emanating from the electronic device while the electronic device is not being operated by the user.

16. A method to authenticate the identity of an electronic device being used in a financial transaction, and, if validated, then authorise the financial transaction, the method including the steps of:
detecting any near-field spurious emissions over a spectral frequency range emanating from said electronic device positioned proximal to a spectral emission detector, wherein the detector is incorporated in or associated with a point-of-sale terminal for a user to conduct a financial transaction;
comparing the detected spurious emissions with a stored signature which is representative of a spurious emission profile of the electronic device; and,
authorising the financial transaction if the identity of said electronic device is validated.

17. The method as claimed in claim 16, wherein, in said comparing step, said detected spurious emissions from said electronic device are compared with a plurality of stored signatures stored in a database;
wherein an algorithm is used which is based on a combination of characteristics of the spurious emissions to determine if the identity of said electronic device is verified; and
wherein a predetermined variance is permitted in determining whether the detected spurious emissions matches the stored signature.

18. (canceled)

19. (canceled)

20. The method as claimed in claim 16, wherein the detected spurious emission includes a primary peak and two secondary peaks smaller than the primary peak, wherein one secondary peak has a lower frequency than the primary peak, and the other secondary peak has a higher frequency than the primary peak, and wherein, in said comparing step, the two secondary peaks are compared with the stored signature to validate the identity of the electronic device.

21. The method as claimed in claim 20, wherein, in said comparing step, the primary peak is ignored when comparing the detected spurious emission with the stored signature.

22. The method as claimed in claim 16, wherein, in said detecting step, the spurious emissions emanating from the electronic device are detected while the electronic device is not being operated by the user.

23. (canceled)

24. (canceled)

25. (canceled)

26. (canceled)

27. (canceled)

28. (canceled)

29. (canceled)

30. A system for authorising a financial transaction, including:
a point-of-sale (POS) terminal, for a user to initiate a financial transaction;
a spectral emission detector, associated with said POS terminal, adapted to detect any near-field spurious emissions over a spectral frequency range emanating from a user's electronic device, the user's electronic device positioned proximal to said detector, and to define a detected signature representative of the user's electronic device;
a memory, containing a plurality of stored signatures, each stored signature being representative of the spurious emission profile of a respective user's electronic device; and
a processor, adapted to compare said detected signature with said stored signatures, and, when a match is identified, provide an authorisation signal to the POS terminal to authorise the financial transaction.

31. The system for authorising a financial transaction as claimed in claim 30, further including a plurality of POS terminals and detectors associated therewith.

32. The system for authorising a financial transaction as claimed in claim 30, wherein each POS terminal is a POS terminal in a retail outlet, a financial institution, a restaurant, or any other service industry; and
wherein each POS terminal and detector optionally includes another authentication apparatus such as but not limited to:
a bCODE scanner;
a QR code scanner;
a PIN device;
a biometric apparatus;
an image scanner;
a heat scanner; and
a signal sniffing detector.

33. (canceled)

34. The system for authorising a financial transaction as claimed in claim 30, wherein said memory and processor are located remotely from each POS terminal and associated detector.

35. The system for authorising a financial transaction as claimed in claim 30, wherein the system operates by:
receiving a request to initiate a financial transaction by a user at a point-of-sale (POS) terminal for the user to conduct a financial transaction;
detecting any near-field spurious emissions over a spectral frequency range emanating from an electronic device presented by the user and positioned proximal to a spectral emission detector associated with said POS terminal;
comparing said detected spurious emissions or a detected signature representative thereof with a stored signature profile for the respective user's electronic device; and,
authorising the financial transaction by providing an authorisation signal to the POS terminal when the detected emissions or signature matches said stored signature profile.

36. (canceled)

37. (canceled)

38. (canceled)

39. (canceled)

40. The system for authorising a financial transaction as claimed in claim 30, wherein said processor is adapted to:
receive an input signal representative of a near-field spurious emission over a spectral frequency range emanated from an electronic device presented to a point-of-sale (POS) terminal by a user and positioned proximal to a spectral emission detector to conduct a financial transaction;
compare said detected spurious emissions with at least one stored signature, each stored signature being representative of a spurious emission profile of a respective electronic device;
validate the identity of said electronic device; and,
provide an authorisation signal to the POS terminal to authorise the financial transaction; and
wherein said processor is located remotely from said POS terminal.

41. (canceled)
